(19) United States
(12) Patent Application Publication
(10) Pub. No.: US 2008/0317306 A1
(43) Pub. Date: Dec. 25, 2008

(54) Methods of and apparatus for forming a biometric image

(76) Inventor: Robin Hamilton, Renfrewshire (GB)

Correspondence Address: MCDERMOTT, WILL & EMERY LLP, 227 WEST MONROE STREET, SUITE 4400, CHICAGO, IL, 60606-5096, US

(21) Appl. No.: 11/820,477

(22) Filed: Jun. 19, 2007

(51) Int. Cl. G06K 9/00

(52) U.S. Cl. 382/128; 382/178; 382/317

(57) ABSTRACT

The invention relates to a method of forming a composite biometric image. The method comprises sensing first and second successive partial images of a biometric object with a sensor during relative movement of the biometric object and the sensor. The sensor comprises an array of sensing elements defining an area smaller than an area of the biometric object to be formed as the composite biometric image and thus the first and second successive partial images overlap each other along a direction of the relative movement. The method also comprises acquiring at least a first image portion and a second image portion from each of the first and second sensed partial images, the first image portion and the second image portion of each comprising different sensed image data along a direction orthogonal to a direction of relative movement of the biometric object and the sensor, the first image portions overlapping with each other, and the second image portions overlapping with each other. The method further comprises: determining first new data of the first image portion of the second partial image absent from the first image portion of the first partial image; and determining second new data of the second image portion of the second partial image not comprised in the second image portion of the first partial image. The method concludes with the formation of the composite biometric image from the image portions in dependence upon the determined first and second new data.

### CROSS-REFERENCE TO RELATED APPLICATIONS

None.

### FEDERALLY SPONSORED RESEARCH OR DEVELOPMENT

Not applicable.

### TECHNICAL FIELD

The present invention relates to methods of and apparatus for forming a biometric image, in particular a composite biometric image.

### BACKGROUND OF THE INVENTION

Fingerprints have long been used to verify the identity of persons. In recent years increasing use has been made of electronic fingerprint recognition methods. Typically, electronic fingerprint recognition methods comprise two main stages; sensing of a person's fingerprint and the acquiring of a fingerprint image from the sensed fingerprint; and analysis of the acquired fingerprint image to verify the person's identity. Analysis of the acquired fingerprint image may, for example, involve comparing the acquired fingerprint image for the person with a database of stored fingerprint images corresponding to known persons.

Fingerprint sensing has been accomplished by means of a sensor having a two-dimensional array of sensor elements of a particular type, e.g. capacitive, piezoelectric or pyroelectric, with the two-dimensional array defining an active surface area of the sensor. An established approach is to use a sensor of active surface area at least as great as a surface area of a fingerprint. In use, a finger is placed on the sensor surface and a whole fingerprint image is acquired. However, this approach has the drawback, amongst others, that large area sensors tend to be costly to manufacture.

More recently this drawback has been addressed by using small area and hence lower cost sensors. Typically, such small area sensors have an active surface area at least as wide as a fingerprint but of significantly less height. In use, the small area sensor and the fingerprint are moved in relation to each other such that a series of partial images of the fingerprint are sensed and acquired. For example, the small area sensor may be immobile and a person may move his finger over the sensor. A composite fingerprint image is then formed from the series of partial images. U.S. Pat. No. 6,459,804 describes such a composite fingerprint image forming method. According to the method of U.S. Pat. No. 6,459,804 a series of overlapping partial images are acquired and a composite fingerprint image is formed from the partial images by using correlation to determine an extent of overlap of adjacent partial images.

The present inventor has appreciated that composite fingerprint image forming methods, such as the method of U.S. Pat. No. 6,459,804, have shortcomings.

It is therefore an object to provide methods of and apparatus for forming a biometric image that provide an improvement over known composite biometric image forming methods and apparatus.

It is a further object to provide methods of and apparatus for forming a composite biometric image.

### SUMMARY OF THE INVENTION

The present invention has been devised in the light of the above mentioned appreciation. Therefore, according to a first aspect of the present invention there is provided a method of forming a composite biometric image, the method comprising:

sensing first and second successive partial images of a biometric object with a sensor during relative movement of the biometric object and the sensor, the sensor comprising an array of sensing elements defining an area smaller than an area of the biometric object to be formed as the composite biometric image, the first and second successive partial images overlapping each other along a direction of the relative movement;

acquiring at least a first image portion and a second image portion from each of the first and second sensed partial images, the first image portion and the second image portion of each comprising different sensed image data along a direction orthogonal to a direction of relative movement of the biometric object and the sensor, the first image portions overlapping with each other, and the second image portions overlapping with each other;

determining first new data of the first image portion of the second partial image absent from (i.e. not comprised in) the first image portion of the first partial image;

determining second new data of the second image portion of the second partial image absent from (i.e. not comprised in) the second image portion of the first partial image; and

forming the composite biometric image from the image portions in dependence upon the determined first and second new data.

In use, the sensor and a biometric object, such as a fingerprint, are moved in relation to each other. For example, a person may move his fingerprint over the sensor. During the relative movement of the biometric object and the sensor at least first and second partial images of the biometric object are sensed by the sensor. Furthermore, at least first and second image portions of each of the first and second sensed partial images are acquired. According to the method, first new data of the first image portion of the second partial image is determined along with second new data of the second image portion of the second partial image. The composite biometric image is formed from the image portions in dependence upon the first and second new data. Thus, the method can provide for the first and second new data being different in size along the direction of relative movement and can take account of the difference in size in forming the composite biometric image.

Taking account of a difference in size of the first and second new data provides advantages over known approaches, such as the approach described in U.S. Pat. No. 6,459,804. More specifically, the speed of relative movement of the biometric object and the sensor may not be the same along a direction orthogonal to the direction of movement. This lack of uniformity in speed of relative movement may, for example, be caused by a difference in friction between a biometric object, such as a fingerprint, and the sensor surface. The difference in friction might, for example, be caused by a patch of grease on the sensor surface or a patch of sweat on the fingerprint. Such a lack of uniformity in speed of movement of the biometric object in the orthogonal direction may result in a difference in size along a direction of relative movement between the first and second new data. The difference between the sizes of the new data can be used in the formation of the composite biometric image to provide for a composite biometric image that takes account of the effect of the lack of uniformity in the speed of relative movement of the biometric object and the sensor.

The present invention may be viewed from another perspective. More specifically, the first new data may be data absent from a first overlap between the first image portions of the first and second partial images. Also, the second new data may be data in a second overlap between the second image portions of the first and second partial images. Thus, the first and second overlaps may be different in size, thereby representing a lack of uniformity in the speed of relative movement at points spaced apart along a direction orthogonal to the direction of relative movement.

More specifically, the array of sensor elements may be at least as wide as and have a length shorter than the area of the biometric object for which a composite biometric image is to be formed. Thus, the method may comprise sensing the first and second successive partial images during relative movement of the biometric object and the sensor along the length of the array of sensor elements.

Known approaches, such as the approach described in U.S. Pat. No. 6,459,804, normally have problems in providing for proper composite biometric image formation when the biometric object and the sensor are moved bodily in relation to each other such that they pivot in relation to each other.

Alternatively or in addition, at least one of: the first image portions of the first and second partial images; and the second image portions of the first and second partial images may be of substantially the same size in the direction orthogonal to the direction of relative movement.

More specifically, corresponding image portions of the first and second partial images may comprise a same number of pixels in the direction orthogonal to the direction of relative movement.

Alternatively or in addition, determining new data comprises determining new data along the direction of relative movement.

Alternatively or in addition, at least one of: the first image portions of the first and second partial images; and the second image portions of the first and second partial images may be of substantially the same size along the direction of relative movement.

More specifically, corresponding image portions of the first and second partial images may comprise a same number of pixels along the direction of relative movement.

Alternatively or in addition, a first image portion and a second image portion of a partial image may be of a different size along the direction of relative movement.

Alternatively or in addition, at least one of: respective image portions of the first and second partial images may be acquired successively from substantially the same part of the sensor array.

Alternatively or in addition, the first and second image portions of a partial image may abut each other along a direction orthogonal to the direction of relative movement.

Alternatively or in addition, the method may comprise acquiring a plurality of image portions from a sensed partial image such that image data sensed by all the sensing elements of the sensor is acquired.

Alternatively, the method may comprise acquiring a plurality of image portions from a sensed partial image such that image data sensed by some of the sensing elements of the sensor is acquired. Thus, the acquisition time can be reduced. Furthermore, data storage requirements can be reduced.

More specifically, the method may comprise providing at least one inferred portion from the acquired plurality of image portions, the at least one inferred image portion comprising image data inferred from the acquired image portions.

More specifically, the at least one inferred image portion may be provided by extrapolation of data contained within at least one of the acquired image portions.

Alternatively or in addition, the acquired plurality of image portions may comprise two abutting acquired image portions and the at least one inferred image portion may comprise three abutting inferred image portions.

More specifically, a centrally disposed one of the three abutting inferred image portions may consist of image data from each of the two abutting acquired image portions.

Alternatively or in addition, a peripherally disposed one of the three abutting inferred image portions may comprise image data from one of the two abutting acquired image portions and image data inferred, e.g. by extrapolation, from the image data of the same one of the two abutting acquired image portions.

Alternatively or in addition, the method may comprise changing a size of an image portion acquired from one partial image to an image portion acquired from a succeeding partial image.

More specifically, changing the size may comprise changing the size along the direction of relative movement.

Alternatively or in addition, changing the size may comprise changing the size along a direction orthogonal to the direction of relative movement.

Alternatively or in addition, the first and second partial images may be immediately succeeding partial images.

Alternatively or in addition, the first partial image may have been sensed before the second partial image.

In a form, the at least one of the first and second new data of corresponding image portions of the first and second partial images may be determined by comparing the corresponding image portions.

More specifically, the first and second image portions may comprise a plurality of rows of pixels. The rows of pixels may extend orthogonally to the direction of relative movement.

More specifically, determining the new data may comprise comparing values of at least one row of pixels of the image portion of the first partial image with values of at least a first row of pixels of the image portion of the second partial image.

More specifically, determining the new data may comprise comparing values of a first row of pixels of the image portion of the first partial image with values in each row of pixels of the image portion of the second partial image.

Alternatively or in addition, the at least one row of the first partial image that is compared may contain new data already determined in respect of the first partial image.

The number of rows of the image portions compared with each other and/or the number of pixels of a total number of pixels in rows that are subject to comparison may be determined in accordance with a cost error function. Thus, a predetermined number of rows of the image portion of the first partial image may be compared with a predetermined number of rows of the image portion of the second partial image. The predetermination may be in accordance with a cost error function.

Alternatively or in addition, a predetermined number of pixels of a row of the image portion of the first partial image may be compared with a predetermined number of pixels of a row of the image portion of the second partial image. The predetermination may be in accordance with a cost error function.

Alternatively or in addition, the step of comparing may comprise determining a difference.

Alternatively or in addition, determining the new data may comprise determining a difference between values of at least one pair of corresponding pixels, a first one of the pair of pixels being from one image portion and a second one of the pair of pixels being from the other image portion.

More specifically, determining the new data may comprise subtracting values of each of a plurality of pixels in a row of the image portion of the first partial image from a value of a corresponding pixel in a row of the image portion of the second partial image.

More specifically, determining the new data may comprise subtracting values of each of a plurality of pixels in a first row of the image portion of the first partial image from a value of a corresponding pixel in at least a first row of the image portion of the second partial image.

More specifically, determining the new data may comprise subtracting values of each of a plurality of pixels in a first row of the image portion of the first partial image from a value of a corresponding pixel in each of a plurality of rows of the image portion of the second partial image.

Alternatively or in addition, determining the new data may comprise determining a square of a difference determined by subtraction of pixel values. Thus, squared difference values may be used in determining the new data instead of the difference value per se.

Alternatively or in addition, determining the new data may comprise summing a plurality of differences determined by subtraction of pixel values.

More specifically, determining the new data may comprise summing differences determined in respect of one row of the image portion of the second partial image. Thus, a first summed difference may be determined.

More specifically, where pixel values of a row of the image portion for the first partial image are subtracted from corresponding pixel values in each of a plurality of rows of the image portion of the second partial image, a plurality of summed differences may be determined, each of the plurality of summed differences being in respect of a different one of the plurality of rows of the image portion of the second partial image.

More specifically, new data of the corresponding image portions may be determined in dependence on a comparison of the plurality of summed differences.

More specifically, the new data may be determined based on the smallest summed difference of the plurality of summed differences.

Thus, the new data may be determined on the basis of a Minimum Least Squares (MLS) approach.

Alternatively or in addition, the first new data of the first image portions may be determined before the second new data of the second image portions where the first image portions have been acquired from closer to a centre of their respective partial images than the second image portions.

Alternatively or in addition, a determination of new data may be carried out between acquisition of image portions from the second partial image and the acquisition of image portions from a further partial image.

Alternatively or in addition, at least one set of new data may be used to make a determination as to a speed of movement of the biometric object and the sensor in relation to each other. For example, a determination may be made that there is no movement of the biometric object and the sensor in relation to each other. Alternatively, for example, a determination may be made that the biometric object and the sensor are moving in relation to each other at particular speed.

More specifically, the method may further comprise the step of comparing a size, along the direction of relative movement, of new data of corresponding image portions with a predetermined movement value and if the size is greater than the predetermined movement value, determining that there is insufficient movement of the biometric image and the sensor in relation to each other.

Alternatively or in addition, the image portions may be acquired from towards a centre of each of the first and second partial images.

Alternatively or in addition, an image portion acquired from the first partial image may comprise one row of pixels.

Alternatively or in addition, an image portion acquired from the second partial image may comprise a plurality of rows of pixels.

More specifically, a number of rows of pixels in the image portion acquired from the second partial image may be determined in dependence upon at least one of: a maximum anticipated speed of movement of the biometric object and the sensor in relation to each other; and a rate of acquisition of image portions.

Alternatively or in addition, in making the determination as to the speed of movement, a comparison may be made between the row of pixels of the first partial image and each row of pixels of the second partial image.

Alternatively or in addition, making a determination as to the speed of movement may comprise determining new data for at least two pairs of image portions acquired from a predetermined number of successive pairs of partial images. For example, new data may be determined in respect of: corresponding image portions acquired from the first and second partial images; corresponding image portions acquired from the second partial image and a third partial image; and corresponding image portions acquired from third and fourth partial images.

More specifically, making a determination as to the speed of movement may further comprise comparing the determined new data.

More specifically, movement of the biometric object and the sensor in relation to each other may be indicated when sizes along the direction of relative movement of new data from partial image to partial image are substantially constant.

Alternatively or in addition, a speed of movement of the biometric object and the sensor in relation to each other may be determined from the determined new data.

Alternatively or in addition, at least one of an acquisition rate and a size of a current image portion acquired from a partial image may be determined in dependence upon new data determined in respect of already acquired corresponding image portions.

More specifically, the partial image from which the current image portion is acquired may be the same as the partial image from which the more recently acquired image portion of the already acquired corresponding image portions has been acquired.

Alternatively or in addition, the determination of new data may be changed (e.g. in respect of a same pair of partial images or a succeeding pair of partial images) in dependence upon new data determined in respect of already acquired corresponding image portions.

More specifically, a number of computation steps involved in the determination of new data may be changed in dependence upon new data determined in respect of already acquired corresponding image portions.

More specifically, an extent to which corresponding image portions are compared to each other may be changed.

More specifically, where determining new data comprises comparing, e.g. by subtraction of pixel values, one row of pixels of an image portion of a first partial image with each of a plurality of rows of pixels of an image portion of a second partial image, the extent to which the image portions are compared to each other may be changed by changing a number of rows of pixels of the image portion of the second partial image with which the row of pixels of the image portion of the first partial image is compared.

Alternatively or in addition, the acquisition of further image portions from the second partial image (e.g. the currently sensed partial image) may be in dependence upon at least one of the sets of new data determined in respect of the pairs of first and second image portions. For example, no further or any number of further image portions may be acquired from the current partial image.

Alternatively or in addition, the determination of the new data of further pairs of image portions (e.g. in the currently sensed and a previously sensed partial image) may be in dependence upon at least one of the new data determined in respect of the pairs of first and second image portions. For example, no further image portion comparisons may be made if the new data determined in respect of the two pairs of first and second image portions are substantially the same; in such a case the new data of such further pairs of image portions may be determined to be the same as the already determined sets of new data.

Alternatively or in addition, at least one image portion may be stored in data memory.

More specifically, the at least one image portion may be stored along with data indicating the location of the image portion in a partial image along a direction orthogonal to the direction of relative movement.

Alternatively or in addition, the at least one image portion may be stored along with data indicating a particular partial image (e.g. the first, the second or a third partial image) from which the image portion has been acquired of a plurality of partial images sensed during relative movement of the biometric object and the sensor.

Alternatively or in addition, the first and second image portions of each of the first and second partial images may be stored in data memory.

More specifically, where the second partial image is sensed after the first partial image, an image portion of the second partial image may be stored in data memory along with a disposition in relation to the corresponding image portion of the first partial image.

Alternatively or in addition, an extent to which an image portion of the second partial image is stored in data memory may depend on its determined new data.

More specifically, where the image portion comprises a plurality of rows of pixels at least none of the rows of pixels of the image portion may be stored in data memory. For example, if for some reason there has been no movement from one image portion to the next then no rows of pixels may be stored. If, on the other hand, there has been movement one or more rows of pixels may be stored in data memory.

Alternatively or in addition, data stored in data memory, such as data contained in an image portion or determined new data, may be compressed. The compression may be in accordance with one or more of the compression techniques that will be well known to the skilled reader.

Alternatively or in addition, the at least one image portion may be stored in data memory between acquisition of image portions from the second partial image and the acquisition of image portions from further partial images.

Alternatively or in addition, where a plurality of image portions from a partial image are stored in data memory, an image portion of the plurality of image portions that is located centre most in the partial image may be stored in data memory first.

More specifically, a second image portion adjacent the centre most image portion may be stored next in the data memory.

More specifically, a third image portion adjacent the centre most image portion and opposing the second image portion may be stored next in the data memory. Thus, storage of image portions may be from a centre of a partial image towards the periphery of the partial image. Furthermore, image portions on alternate sides of the centre most image portion may be stored in turn in the data memory.

Alternatively or in addition, the composite biometric image may be formed from data of at least one image portion stored in data memory.

Alternatively or in addition, the composite biometric image may be formed from data of at least the first and second image portions of each of the first and second partial images.

Alternatively or in addition, the step of forming the composite biometric image may comprise forming a first image column from data of the first image portions of the at least first and second partial images and forming a second image column from data of the second image portions of the at least first and second partial images.

More specifically, an image column may be formed by disposing its respective image portion data such that data of neighbouring image portions abut each other at edges having a direction substantially orthogonal to the direction of relative movement. For example, in forming the first image column data of the first image portions of the first and second partial images may be disposed such that they abut each other.

Alternatively or in addition, the step of forming the composite biometric image may further comprise disposing image columns in relation to each other.

More specifically, the first image column and the second image column may be disposed such that they abut each other at edges having a direction substantially along the direction of relative movement.

Alternatively or in addition, the first image column and the second image column may be aligned with each other along the direction of relative movement.

More specifically, the first and second image columns may be aligned such that a free edge of data of an image portion (e.g. an edge of data of an image portion that is not abutting data of another image portion) of the first image column is in registration with data of a free edge of an image portion of the second image column.

More specifically, the image portion data having the free edge may have been acquired from a first partial image sensed during relative movement of the sensor and the biometric object being used in formation of the composite biometric image.

Alternatively or in addition, the first image column may be formed before the second image column, the first image column having data from image portions that have been acquired from closer to a periphery of the partial images than data from the image portions comprised in the second image column. Thus, the composite biometric image may be formed by disposing image portions from one side of the biometric image to the opposing side of biometric image, e.g. by working from left to right along a direction orthogonal to the direction of relative movement.

Alternatively or in addition, the step of forming a composite biometric image may comprise disposing data from a plurality of image portions acquired from a first partial image in relation to each other followed by disposing data from a plurality of image portions acquired from a second partial image in relation to each other.

Alternatively or in addition, the step of forming the composite biometric image may continue until at least one of: a height of the thus formed composite biometric image along the direction of relative movement exceeds a predetermined height value; and data from all image portions acquired from sensed partial images have been disposed in image columns.

Alternatively or in addition, an image portion may be acquired from a partial image and new data may be determined in respect of the image portion before a further image portion is acquired from a partial image.

Alternatively or in addition, at least one pixel in an image portion may consist of binary data. Thus, an amount of data sensed, acquired, stored and processed may be reduced, thereby deriving advantages in power consumption, performance and product cost.

In another form of the invention, the method may comprise processing at least one pixel of an image portion to improve upon the use of a dynamic range of the pixel by the data contained in the pixel.

More specifically, processing at least one pixel may comprise applying compression to the data contained in the pixel.

More specifically, logarithmic compression may be applied to the data contained in the at least one pixel.

Alternatively or in addition, processing at least one pixel may comprise applying a logarithmic function to the data contained in the pixel.

Alternatively or in addition, at least one pixel of an image portion may be processed in dependence upon data contained in at least one pixel of a currently sensed partial image.

Alternatively or in addition, at least one pixel of an image portion may be processed in dependence upon data contained in at least one pixel of a previously sensed partial image.

Alternatively or in addition, at least one pixel of an image portion may be processed in dependence on an average amplitude of data contained in pixels of at least one partial image. For example, if, during the relative movement, the average amplitude drops (thereby, for example, indicating a patch of poor skin to sensor contact) a gain of an amplifier is increased in dependence in the drop in amplitude.

Alternatively or in addition, the processing of at least one pixel may be in dependence upon a determination of new data for corresponding image portions.

Alternatively or in addition, at least one pixel of a plurality of pixels of an image portion may be selectively processed in dependence upon determined new data for corresponding image portions.

In another form, the method may further comprise controlling an acquisition time between acquisition of one image portion and another image portion in dependence upon a determination of new data for already acquired corresponding image portions. For example, where the speed of movement of the biometric object and the sensor in relation to each other is decreasing as indicated by an increase in a size of new data along the direction of relative movement, the acquisition time may be increased.

Alternatively, for example, where the speed of movement of the biometric object and the sensor in relation to each other is increasing as indicated by a decrease in a size of the new data, the acquisition time may be decreased.

More specifically, the method may further comprise comparing the size of the new data with at least one predetermined size value and controlling the acquisition time in dependence upon the comparison.

More specifically, the at least one predetermined size value may comprise a high size value and a low size value and the acquisition time may be controlled to maintain the size of the new data between the high size value and the low size value.

Alternatively or in addition, the acquisition time may be reduced if the size of the new data is less than or equal to half the height of an image portion.

Alternatively or in addition, the biometric object may comprise a fingerprint. Thus, the composite biometric image may comprise a composite fingerprint image.

Alternatively or in addition, the method may comprise keeping the biometric object and the sensor in contact with each other as the biometric object and the sensor are moved in relation to each other while the image portions are acquired from the partial images.

Alternatively or in addition, the biometric object may be moved in relation to the sensor.

Alternatively or in addition, the sensor may be operative to sense the biometric object on the basis of a thermal principle.

More specifically, the sensor may comprise sensor elements operative on the pyroelectric principle.

According to a second aspect of the present invention, there is provided a computer program comprising executable code that upon installation on a computer comprising a sensor causes the computer to form a composite biometric image by executing the procedural steps of:

sensing first and second successive partial images of a biometric object with the sensor during relative movement of the biometric object and the sensor, the sensor comprising an array of sensing elements defining an area smaller than an area of the biometric object to be formed as the composite biometric image, the first and second successive partial images overlapping each other along a direction of the relative movement,

acquiring at least a first image portion and a second image portion from each of the first and second sensed partial images, the first image portion and the second image portion of each comprising different sensed image data along a direction orthogonal to a direction of relative movement of the biometric object and the sensor, the first image portions overlapping with each other, and the second image portions overlapping with each other;

determining first new data of the first image portion of the second partial image absent from (i.e. not comprised in) the first image portion of the first partial image;

determining second new data of the second image portion of the second partial image absent from (i.e. not comprised in) the second image portion of the first partial image; and

forming the composite biometric image from the image portions in dependence upon the determined first and second new data.

More specifically, the computer program may be embodied on at least one of: a data carrier; and read-only memory.

Alternatively or in addition, the computer program may be stored in computer memory.

Alternatively or in addition, the computer program may be carried on an electrical carrier signal.

Further embodiments of the second aspect of the present invention may comprise at least one optional feature of the first aspect of the present invention.

According to a third aspect of the present invention there is provided an apparatus for forming a composite biometric image, the apparatus comprising:

a sensor operative to sense first and second successive partial images of a biometric object during relative movement of the biometric object and the sensor, the sensor comprising an array of sensing elements defining an area smaller than an area of the biometric object to be formed as the composite biometric image, the apparatus being operative to sense the first and second successive partial images such that they overlap each other along a direction of the relative movement;

data acquisition apparatus operative to acquire at least a first image portion and a second image portion from each of the first and second sensed partial images such that: the first image portion and the second image portion of each comprises different sensed image data along a direction orthogonal to a direction of relative movement of the biometric object and the sensor, the first image portions overlap each other, and the second image portions overlap each other; and

a processor operative to: determine first new data of the first image portion of the second partial image absent from (i.e. not comprised in) the first image portion of the first partial image; determine second new data of the second image portion of the second partial image absent from (i.e. not comprised in) the second image portion of the first partial image; and form the composite biometric image from the image portions in dependence upon the determined first and second new data.

More specifically, the apparatus may comprise a computer (such as a Personal Computer), the computer comprising the processor and the data acquisition apparatus.

More specifically, the computer may further comprise data memory operative to store at least one of: the image portions; and the composite biometric image.

Alternatively or in addition, the computer may comprise the sensor.

More specifically, the sensor may be integral to the computer. For example, the sensor may be provided in the vicinity of a keyboard of the computer, the sensor forming, along with the rest of the apparatus of the present invention, means of gaining secure access to and use of the computer.

Alternatively or in addition, the apparatus may comprise an embedded microcomputer, the processor forming part of the embedded microcomputer. Thus, the microcomputer may form part of apparatus operative to identify persons. For example, the apparatus operative to identify persons may be used at airports, ports and similar such points of entry to a country.

Alternatively or in addition, the sensor may consist of two rows of sensor elements. The difference based approach to determining new data described above may provide for the use of a sensor having only two rows of pixels. This is an advantage compared, for example, with known correlation approaches to determining extents of overlap, which normally require at least three rows of pixels in a sensor. More specifically, this embodiment can provide for a significant reduction in sensor design and manufacturing cost. Also, this embodiment can provide for a reduction in data processing requirements with attendant advantages of: reduced cost of processing electronics; and reduced power consumption.

Further embodiments of the third aspect of the present invention may comprise one or more optional features of any of the first and second aspects of the present invention.

The present inventor has realised that determining the new data of an image portion by means of determining differences may have wider application than hitherto described. Thus, from a fourth aspect of the present invention there is provided a method of forming a composite biometric image, the method comprising:

sensing first and second successive partial images of a biometric object with a sensor during relative movement of the biometric object and the sensor, the sensor comprising an array of sensing elements defining an area smaller than an area of the biometric object to be formed as the composite biometric image, the first and second successive partial images overlapping each other along a direction of the relative movement;

acquiring an image portion from each of the first and second partial images, the acquired image portions overlapping each other;

determining new data of the image portion of the second partial image absent from (i.e. not comprised in) the image portion of the first partial image, the step of determining the new data comprising determining a difference between values of at least one pair of corresponding pixels, a first one of the pair of pixels being from one image portion and a second one of the pair of pixels being from the other image portion; and

forming the composite biometric image from the image portions in dependence upon the determined new data.

More specifically, an image portion may correspond to a part of the partial image from which it is acquired.

Alternatively or in addition, the method may comprise acquiring at least a first image portion and a second image portion of each of the first and second sensed partial images, the first image portion and the second image portion of each comprising different sensed image data along a direction orthogonal to a direction of relative movement of the biometric object and the sensor.

More specifically, the step of determining new data may comprise determining a size of the new data of the first image portion along the direction of relative movement.

Alternatively or in addition, the step of determining new data may comprise determining a size of the new data of the second image portion along the direction of relative movement.

Further embodiments of the fourth aspect of the present invention may comprise one or more optional features of any of the first to third aspects of the present invention.

According to a fifth aspect of the present invention, there is provided an apparatus for forming a composite biometric image, the apparatus comprising:

a sensor operative to sense first and second successive partial images of a biometric object during relative movement of the biometric object and the sensor, the sensor comprising an array of sensing elements defining an area smaller than an area of the biometric object to be formed as the composite biometric image, the apparatus being operative such that the first and second successive partial images overlap each other along a direction of the relative movement;

acquisition apparatus operative to acquire an image portion from each of the first and second partial images, the acquired image portions overlapping each other;

a processor operative to: determine new data of one of the image portions absent from (i.e. not comprised in) the other of the image portions, determining the new data comprising determining a difference between values of at least one pair of corresponding pixels, a first one of the pair of pixels being from one image portion and a second one of the pair of pixels being from the other image portion; and form the composite biometric image from the image portions in dependence upon the determined new data.

Embodiments of the fifth aspect of the present invention may comprise one or more optional features of the previous aspects of the present invention.

The present inventor has realised that the step of processing at least one pixel of an image portion to improve upon the use of a dynamic range of the pixel by the data contained in the pixel has wider application than hitherto described. Thus, according to a sixth aspect of the present invention there is provided a method of forming a composite fingerprint image, the method comprising:

sensing first and second successive partial images of a fingerprint with a sensor during relative movement of the fingerprint and the sensor, the sensor comprising an array of sensing elements defining an area smaller than an area of the fingerprint to be formed as the composite fingerprint image;

acquiring an image portion from each of the first and second partial images;

forming the composite fingerprint image from the image portions;

in which the method comprises processing at least one pixel of an image portion to improve upon the use of a dynamic range of the pixel by the data contained in the pixel.

More specifically, processing at least one pixel may comprise changing a magnitude of the data contained in the pixel.

Alternatively or in addition, processing at least one pixel may comprise applying compression to the data contained in the pixel.

More specifically, logarithmic compression may be applied to the data contained in the at least one pixel.

Alternatively or in addition, processing at least one pixel may comprise applying a logarithmic function to the data contained in the pixel.

Alternatively or in addition, the method may further comprise sensing the first and second successive partial images such that the first and second successive partial images overlap each other along a direction of the relative movement.

More specifically, the method may further comprise determining new data of the image portion of the first partial image absent from the image portion of the second partial image.

More specifically, the step of determining new data may comprise subtracting values of at least one pair of corresponding pixels from each other, a first one of the pair of pixels being from one image portion and a second one of the pair of pixels being from the other image portion.

Alternatively or in addition, the step of forming the composite fingerprint image from the image portions may be in dependence upon the determined new data.

Further embodiments of the sixth aspect of the present invention may comprise one or more features of any one of the previous aspects of the present invention.

According to a seventh aspect of the present invention, there is provided an apparatus for forming a composite fingerprint image, the apparatus comprising:

a sensor operative to sense first and second successive partial images of a fingerprint during relative movement of the fingerprint and the sensor, the sensor comprising an array of sensing elements defining an area smaller than an area of the fingerprint to be formed as the composite fingerprint image;

acquisition apparatus operative to acquire an image portion from each of the first and second partial images; and

a processor operative to form the composite fingerprint image from the image portions,

in which the processor is operative to process at least one pixel of an image portion to improve upon the use of a dynamic range of the pixel by the data contained in the pixel.

Embodiments of the seventh aspect of the present invention may comprise one or more features of any one of the previous aspects of the present invention.

The present inventor has realised that the step of controlling an acquisition time between the acquisition of one image portion and another image portion in dependence upon a determination of new data for already acquired image portions has wider application than hitherto described. Thus, according to an eighth aspect of the present invention there is provided a method of forming a composite fingerprint image, the method comprising:

sensing first and second successive partial images of a fingerprint with a sensor during relative movement of the fingerprint and the sensor, the sensor comprising an array of sensing elements defining an area smaller than an area of the fingerprint to be formed as the composite fingerprint image, the first and second successive partial images overlapping each other along a direction of the relative movement;

acquiring an image portion from each of the first and second partial images, the image portions overlapping each other;

determining new data of the image portion of the second partial image absent from (i.e. not comprised in) the image portion of the first partial image;

forming the composite fingerprint image from the image portions in dependence upon the determined new data; and

controlling an acquisition time between the acquisition of one image portion and another image portion in dependence upon new data determined for already acquired corresponding image portions.

Embodiments of the eighth aspect of the present invention may comprise one or more optional features of any one of the previous aspects of the present invention.

According to an ninth aspect of the present invention there is provided an apparatus for forming a composite fingerprint image, the apparatus comprising:

a sensor operative to sense first and second successive partial images of a fingerprint during relative movement of the fingerprint and the sensor, the sensor comprising an array of sensing elements defining an area smaller than an area of the fingerprint to be formed as the composite fingerprint image, the apparatus operative such that the first and second successive partial images overlap each other along a direction of the relative movement;

acquisition apparatus operative to acquire an image portion from each of the first and second partial images, the image portions overlapping each other; and

a processor operative to: determine new data of the image portion of the second partial image absent from (i.e. not comprised in) the image portion of the first partial image; form the composite fingerprint image from the image portions in dependence upon the determined new data; and control an acquisition time between the acquisition of one image portion and another image portion in dependence upon a determination of new data for already acquired corresponding image portions.

Embodiments of the ninth aspect of the present invention may comprise one or more features of any one of the previous aspects of the present invention.

### BRIEF DESCRIPTION OF THE DRAWINGS

Specific embodiments of the present invention will now be described with reference to the accompanying drawings, in which:

FIG. 1 is a representation of apparatus for forming a biometric image according to the present invention;

FIG. 2a is a representation of a view of a fingerprint in contact with the sensor of the apparatus of FIG. 1;

FIG. 2b is a representation of sensed levels of contact between a fingerprint and sensor elements of the sensor of FIG. 1;

FIG. 2c is plan view schematic of pixels of the sensor of FIG. 1;

FIG. 3a shows a series of data acquisition cycles carried out by the data acquisition apparatus of FIG. 1;

FIG. 3b shows a series of image portions acquired from the sensor of FIG. 1;

FIG. 4 provides a flow chart representation of a method of forming a biometric image in accordance with the present invention;

FIG. 5a shows the acquisition of image portions from a partial fingerprint image;

FIG. 5b shows the derivation of inferred image portions from acquired image portions;

FIG. 6 illustrates the detection of movement of a fingerprint over a sensor;

FIG. 7 illustrates the logarithmic compression applied to data contained in pixels of image portions;

FIG. 8 illustrates the acquisition of image portions for formation of a composite fingerprint image;

FIG. 9 illustrates the determination of new data of image portions;

FIG. 10 illustrates the caching of image portions;

FIGS. 11a to 11c illustrated the formation of a composite fingerprint image from a number of image portions; and

FIG. 12 shows an image portion acquisition time period changing where there is a change in speed of movement of a fingerprint.

### DETAILED DESCRIPTION

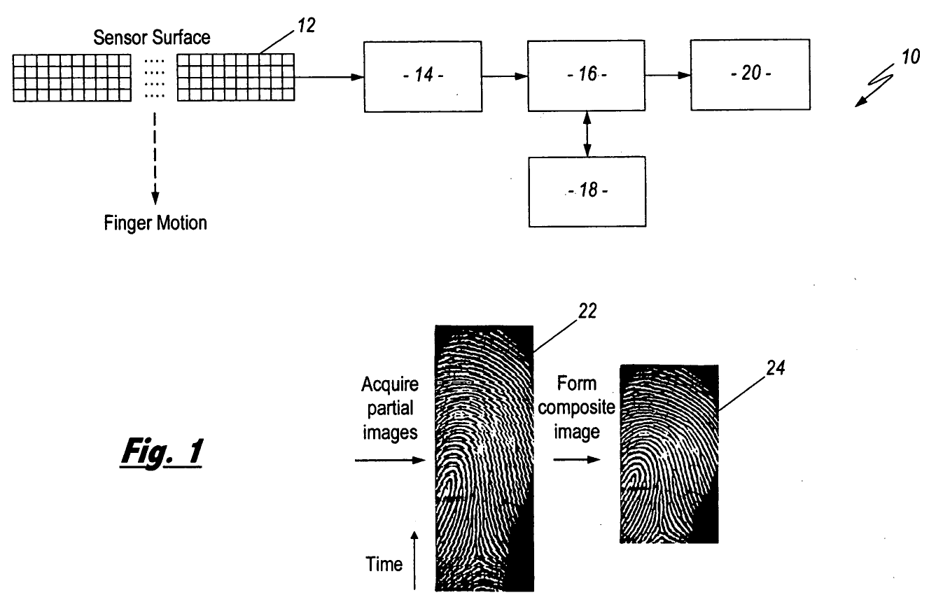

A representation of apparatus 10 for forming a biometric image according to the present invention is shown in FIG. 1. The apparatus 10 comprises a sensor 12, which is operable to sense part of a fingerprint (which constitutes a biometric object), data acquisition apparatus 14, a processor 16, data memory 18 and an input/output device 20.

A part of a fingerprint sensed by the sensor 12 is acquired by the data acquisition apparatus 14. The form and function of the data acquisition apparatus is in accordance with well known practice. For example, the data acquisition apparatus 14 may comprise a sample and hold device, an analogue to digital converter and associated support electronics as are readily and widely available from manufacturers of standard electronic components. The digital data acquired from the sensor 12 by the data acquisition apparatus 14 is conveyed to the processor 16 and processed as described in detail below. The processor 16 may comprise a microprocessor as may form part of a computer system or a microcontroller as may form part of an embedded system. The apparatus 10 also comprises data storage memory 18, which may take the form of solid-state memory, magnetic media or optical media. The form of data storage memory 18 will depend on the form of the apparatus 10 of the present invention. The input/output device 20 may be: a printer that is operable to print a representation of a composite fingerprint image according to the present invention; a display, such as a standard Personal Computer (PC) display, that is operable to display a representation of a composite fingerprint image; or further apparatus that is operable to process a composite fingerprint image, such as fingerprint recognition apparatus.

FIG. 1 also shows partial images 22 of the fingerprint as acquired by the data acquisition apparatus 14 and a composite image 24 of the fingerprint formed from the partial images as described below.

Although not illustrated, the apparatus 10 of FIG. 1 may form part of a Personal Computer, with the sensor forming an integral part of the Personal Computer. Alternatively, the apparatus 10 of FIG. 1 may form part of apparatus configured for a dedicated purpose, such as security apparatus at an airport, which is operable to check the identities of persons passing through a control point.

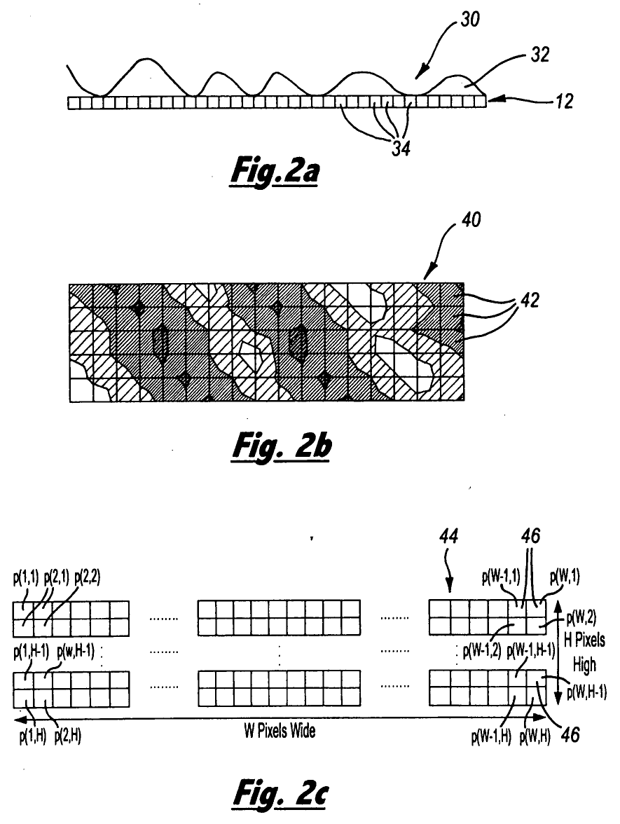

FIG. 2a is a representation of a cross sectional view of a fingerprint 32 in contact with the sensor 12 of FIG. 1. The profile of the fingerprint 32 shown in FIG. 2a represents the features of the fingerprint. The sensor 12 comprises a two-dimensional array of sensor elements 34. The sensor 12 operates on the pyroelectric principle. For example, the sensor 12 may be a FingerChip® from Atmel. According to the pyroelectric principle, the sensor elements 34 measure a temperature difference in accordance with a level of contact between the finger and the sensor elements. FIG. 2b is a representation 40 of sensed levels of contact between a fingerprint 32 and the sensor elements 34. In contrast with FIG. 2a, FIG. 2b provides a plan view representation. Thus, the two-dimensional array of pixels 42 in the representation 40 of FIG. 2b corresponds to the two-dimensional array of sensing elements 34 of the sensor 12 of FIG. 2a. In another form, each sensor element has a binary output, i.e. each element provides either a ‘0’ or ‘1’ in response to part of a sensed fingerprint. This form provides for simpler, lower cost sensors as well as providing for a reduction in data storage and processing requirements. FIG. 2c provides a plan view schematic of the array 44 of pixels shown in FIG. 2b; according to FIG. 2c, the array is H pixels 46 high and W pixels 46 wide. In forms of the sensor of FIG. 1 and FIGS. 2a to 2c, the sensor 12 has only two rows of sensor elements 34. Processing of partial images to determine new data of an image portion, as is described below, can be accomplished with data from only two rows of sensor elements in comparison with correlation based approaches which need at least three rows of sensor elements.

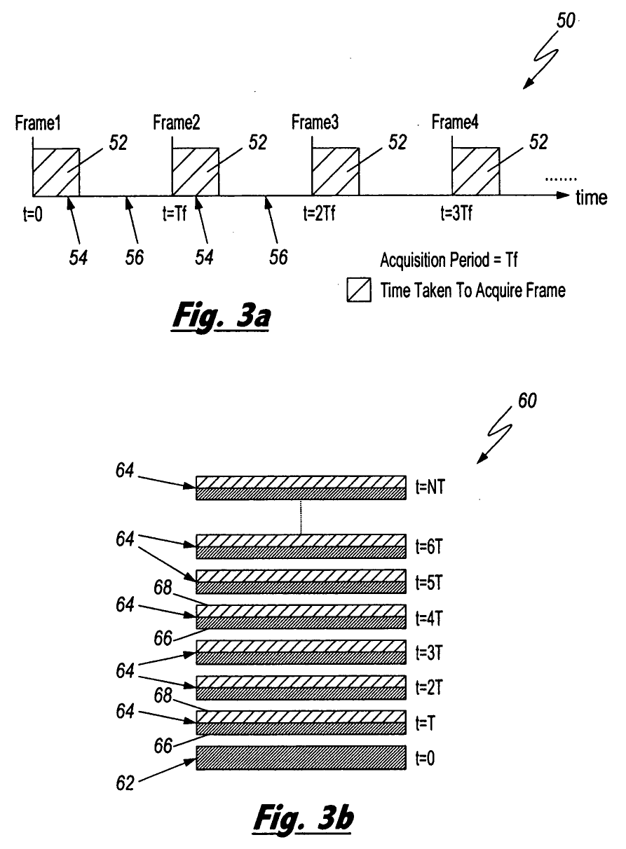

As can be seen from FIG. 1, the sensor 12 is as wide as but much shorter than the fingerprint to be sensed. Thus, in use of the apparatus 10 of FIG. 1, the fingerprint is moved in relation to the sensor 12 along the length of the sensor such that the movement brings the entire fingerprint to be sensed into contact with the sensor elements 34. To provide a composite fingerprint image (which constitutes a composite biometric image), the data acquisition apparatus 14 acquires a succession of data from the sensor and the processor forms the composite image from the succession of data, as is described in detail below. The series of data acquisition cycles carried out by the data acquisition apparatus 10 is illustrated in FIG. 3a. As can be seen from FIG. 3a, a series of image portions 52 (or frames as they are termed in FIG. 3a) are acquired from the sensor 12. Each acquisition cycle comprises an acquisition time 54 during which the acquisition of data is being carried out and a period 56 during which no acquisition is carried out. The period 56 during which no acquisition is carried out is varied as described below.

To allow for the series of image portions 52 acquired from the sensor 12 to be formed as a composite image, time adjacent image portions are brought into registration with each other. The registration process according to the present invention is described below in detail. It should be noted that the registration process relies on there being an overlap between adjacent image portions. The overlapping of adjacent image portions is represented 60 in FIG. 3b. More specifically, FIG. 3b shows a series of spaced apart image portions comprising a first acquired image portion 62, which consists of data that is not shared with any other image portion, and further acquired image portions 64 (1^{st} to N^{th} image portions). Each of the further image portions 64 consists of data seen for the first time (i.e. new data) by the sensor 68 and data already acquired 66 in the immediately preceding image portion. Thus, data of an image portion 64 and of its immediate predecessor may be brought into registration with each other as part of the formation of the composite fingerprint image by identifying the new data of the more recently acquired image portion. It is to be appreciated that a change in the speed of movement of the fingerprint over the sensor 12 and during acquisition of image portions will change a size of new data from one image portion to the next. Thus, this approach to composite image formation provides a means whereby changes in speed of fingerprint movement can be accommodated, within certain limits.

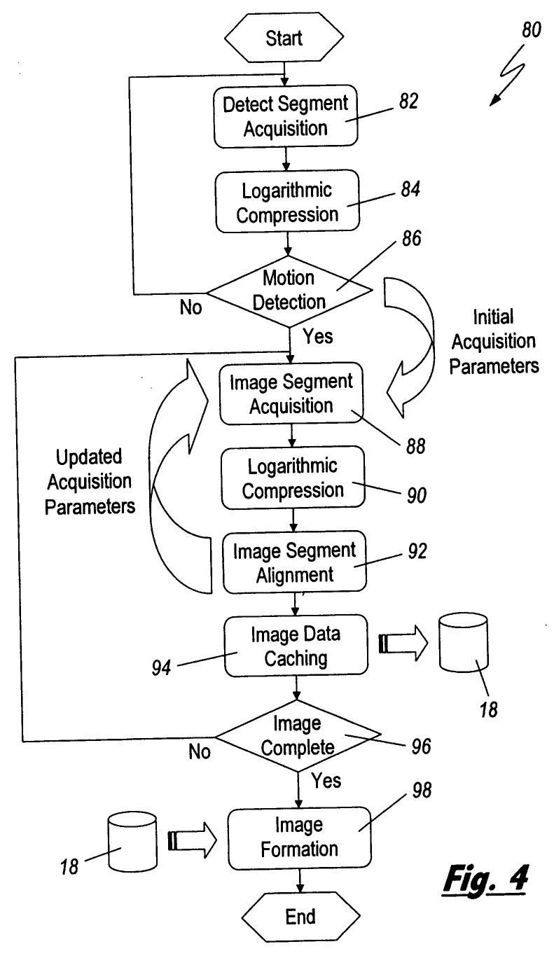

A flow chart representation of a method of forming a biometric image using the apparatus of FIG. 1 is shown in FIG. 4. The steps in the method of FIG. 4 will now be described in outline. A more detailed description of the steps of FIG. 4 follows.

The method 80 starts with a first phase, namely the detection of movement of a fingerprint over a sensor. The first phase comprises the sensing and acquisition 82 of image portions, the logarithmic compression 84 of data in pixels of acquired image portions, and the processing 86 of the acquired and compressed image portions to determine whether or not there is movement of a fingerprint over the sensor. If no movement is determined, the first phase recommences. If movement is determined, the method 80 progresses to the acquisition of adjacent image portions 88, which are to be used in the formation of a composite fingerprint image. The acquired image portions are subject to logarithmic compression 90. Then the adjacent image portions are brought into registration with each other 92 (or aligned as specified in FIG. 4). An image portion that has been brought into registration with an adjacent image portion is then stored 94 in data memory 18. The method 80 then involves determining whether or not a sufficient number of image portions have been acquired to form the composite fingerprint image 96. If not, at least one further image portion is acquired 88 and the logarithmic compression 90, registration 92 and storage 94 steps are repeated. If so, the method proceeds to the image formation step 98, in which image portions stored in data memory 18 are recovered and formed as the composite fingerprint image.

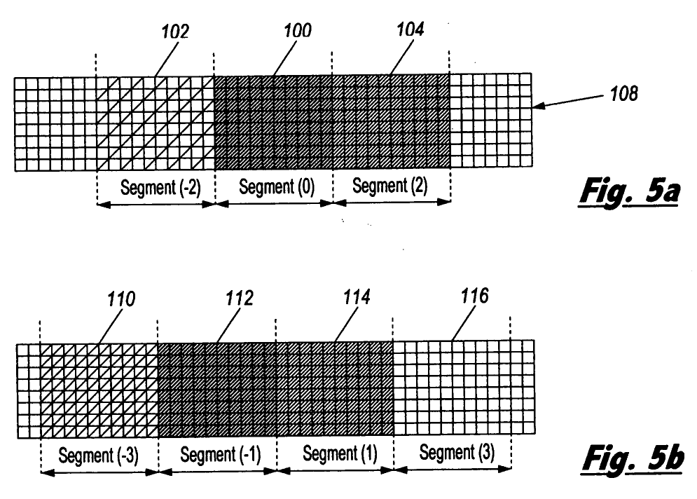

During the acquisition of image portions during the first movement detection phase and the subsequent phase of acquiring image portions for composite image formation (i.e. steps 82 and 88 in FIG. 4), an approach illustrated in FIG. 5a is followed. FIG. 5a shows image portions 100, 102 and 104 acquired from the array of sensor elements 108 of the sensor 12 shown in FIG. 1. More specifically, the pixels of the array of sensor elements 108 contain at any one time what may be considered to be a partial image of the fingerprint. The approach according to the present invention involves acquiring a plurality of image portions from the partial image. In the example shown in FIG. 5a, three image portions are acquired from the partial image. The image portions are acquired in turn: first the central image portion 100; next an image portion 102 towards one side of the central image portion; and then an image portion 104 towards the other side of the central image portion. Thus, not all of the pixels of the partial image are acquired for processing. The extent to which the pixels are acquired is discussed further below.

FIG. 5b shows how further image portions can be inferred from the image portions 100 to 104 acquired from the sensed partial image shown in FIG. 5b. FIG. 5b shows four inferred image portions 110 to 116. One of the centre most inferred image portions 112 is formed such that it consists of half of the data contained in the centre most acquired image portion 100 and half of the data contained in one of the peripherally located acquired image portions 102. The other of the centre most inferred image portions 114 is formed such that it consists of the other half of the data contained in the centre most acquired image portion 100 and half of the data contained in the other one of the peripherally located acquired image portions 104. One of the peripherally located inferred image portions 110 consists of the other half of the data contained in one of the peripherally located acquired image portions 102 and data inferred from data contained in that image portion. The data is inferred by extrapolation of the data contained in the acquired image portion 102. Extrapolation is by means of well known techniques. The other of the peripherally located inferred image portions 116 consists of the other half of the data contained in the other one of the peripherally located acquired image portions 104 and data inferred from data contained in that image portion. As with the other inferred image portion, the data is inferred by extrapolation of the data contained in the acquired image portion 104. The deriving of inferred image portions as described with reference to FIG. 5b reduces the need to acquire image portions from a partial image and thereby reduces the acquisition time.

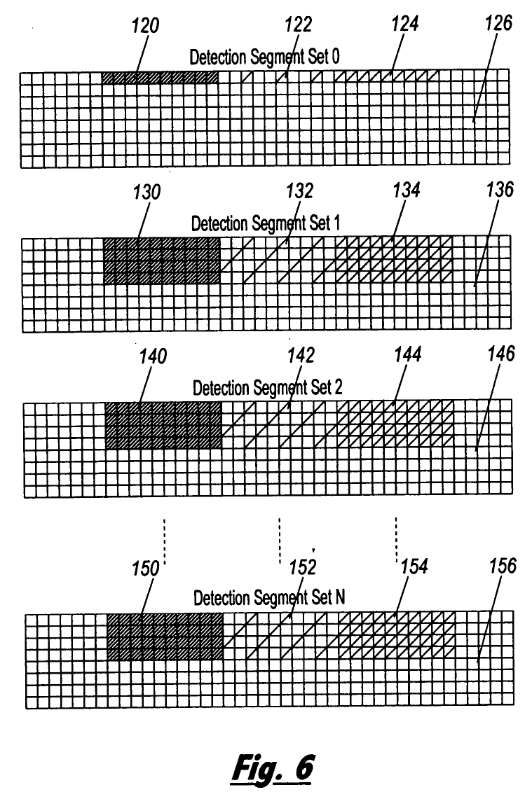

The detection of movement of the fingerprint over the sensor will now be described with reference to FIG. 6. A first set of image portions consisting of three image portions 120 to 124 is acquired from a first partial image 126 of the fingerprint. The three image portions are located centrally in the first partial image 126. Each of the three image portions 120 to 124 consists of a single row of pixels, each pixel corresponding to a different sensor element 34 of the sensor 12. Then a second set of image portions 130 to 134 is acquired from a second partial image 136 of the fingerprint. The second set of image portions 130 to 134 are acquired from the same central location of the partial image as the first set of image portions 120 to 124. Each image portion of the second set of image portions 130 to 134 consists of four rows of pixels. The processor 14 of the apparatus 10 of FIG. 1 then determines new data of the first image portion 120 of the first set of image portions absent from the first image portion 130 of the second set of image portions. The new data is determined by comparing the single row of the first image portion 120 of the first set with each of the four rows of the first image portion of the second set. The means of comparison of the rows is described in more detail below. When determination of the new data of the corresponding first image portions of the first and second sets is complete, the processor turns to determining new data of the corresponding second image portions 122, 132 of the first and second sets of image portions in the same fashion as for the corresponding first image portions. Finally, the processor 16 determines the new data of the corresponding third image portions 124, 134 of the first and second sets of image portions in the same fashion as for the corresponding first image portions. A third set of image portions 140 to 144 is acquired from a third partial image 146 of the fingerprint. The third set of image portions 140 to 144 are acquired from the same central location of the partial image as the first and second sets of image portions 120 to 124 and 130 to 134. Each image portion of the third set of image portions 140 to 144 consists of four rows of pixels. The processor 14 then determines new data of the corresponding first image portions 130, 140 of the second and third sets of image portions. The new data is determined by comparing the first row of the first image portion 130 of the first set with each of the four rows of the third image portion 140 of the second set. When the new data of the corresponding first image portions of the second and third sets is complete, the processor turns to determining the new data of the corresponding second image portions 132, 142 and then the new data of the corresponding third image portions 134, 144 of the second and third sets of image portions in the same fashion as for the corresponding first image portions. Further sets of image portions 150 to 154 are acquired from further partial images 156 until it is determined that there is movement of the fingerprint over the sensor. The number of rows of pixels to be acquired from the second and successive partial images is determined on the basis of an anticipated maximum speed of movement and the limit on acquisition time imposed by the data acquisition apparatus.

Movement of the fingerprint over the sensor is determined on the basis of the new data determined as described in the immediately preceding paragraph. More specifically, if size along a direction of relative movement of new data is greater than a predetermined value, which is indicative of little or no movement, then it is determined that there is insufficient movement of the fingerprint over the sensor to begin acquiring image portions for formation of a composite image. Also, the sizes of new data for each of a number of successive partial images are compared with each other to determine if the fingerprint is moving at a substantially constant speed. If the speed of movement is substantially constant, then acquisition of image portions for formation of a composite image begins. If not, the user is instructed to move his or her fingerprint over the sensor again.

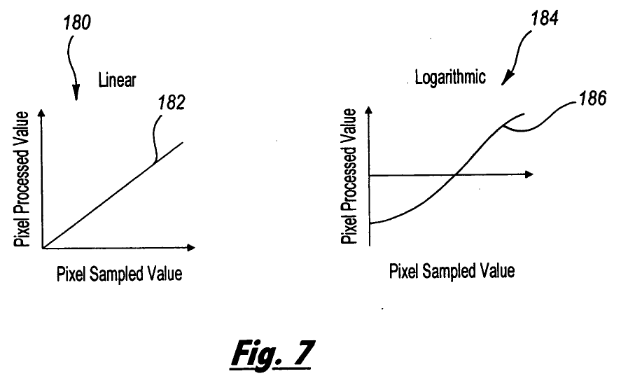

The logarithmic compression applied to data contained in pixels of image portions is described with reference to FIG. 7. As described above, logarithmic compression is applied during determination of movement of the fingerprint over the sensor and during processing of image portions acquired for composite image formation. The left hand graph 180 shows a linear (i.e. uncompressed) relationship 182 between acquired pixel data and pixel data that is processed either as part of the movement detection process or the image portion registration process. The right hand graph 184 shows a non-linear (i.e. compressed) relationship 186 between acquired pixel data and pixel data that is processed either as part of the movement detection process or the image portion registration process. The non-linear relationship involves logarithmic compression of the acquired pixel data. The effect of the logarithmic compression is to emphasise data level contrast in a part or parts of the dynamic range of the pixel data. In the right hand graph 184, the compression relationship 186 is such as to emphasise data levels towards the centre of the dynamic range. The logarithmic compression is carried out in accordance with well known logarithmic compression techniques. According to the present application of logarithmic compression, the logarithmic compression function is changed in dependence on data contained in previously acquired image portions. For example, if it is determined that such data is biased towards an upper end of the dynamic range then the logarithmic compression function is changed to provide the appropriate emphasis of subsequently acquired data.

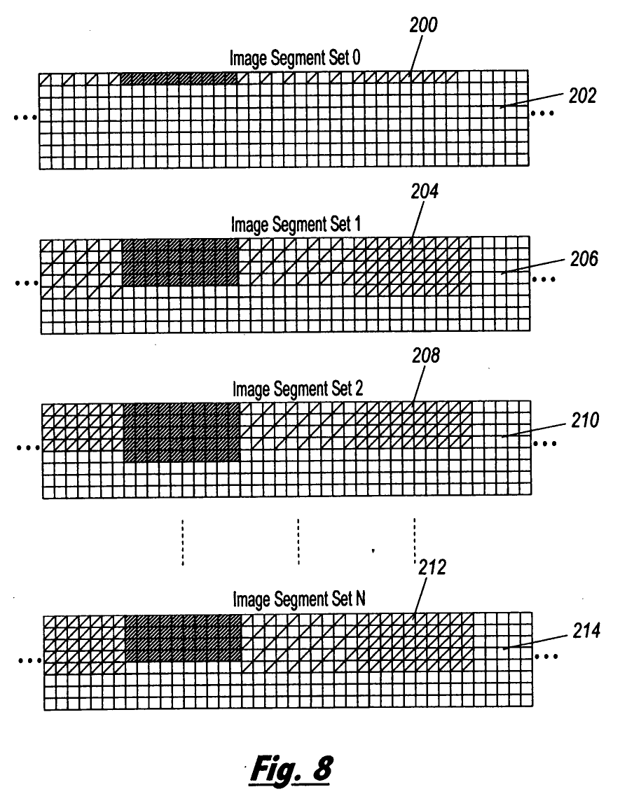

The acquisition of image portions for formation of the composite fingerprint image will now be described with reference to FIG. 8. The image portion acquisition period (i.e. the time between one acquisition and the next) is set on the basis of the new data determined during the movement detection process. As a first step, a first set of image portions 200 is acquired from a first partial image 202. Each image portion in the first set is of only one row of pixels. Then a second set of image portions 204 is acquired from a second partial image 206. As per the movement detection process, new data of corresponding first image portions of the first and second sets 200, 204 is determined. This involves comparing data contained in the pixels of the single row of the first image portion of the first set with data contained in each row of pixels of the first image portion of the second set. The new data determination is repeated for each of corresponding second, third, fourth, etc image portions of the first and second sets 200, 204 until all the acquired image portions have been processed. The first set of image portions is stored in data memory 18 as it is. The new data determined in respect of each image portion of the second set of image portions 204 determines how many rows of each is stored in data memory 18. For example, if the new data is determined such that the new data comprises only one row of an image portion, only that row comprised in the new data is stored in the data memory. Thus, it can be seen that each of the corresponding image portions can have different new data whereby different speeds of movement of the fingerprint across the width of the sensor can be accommodated.

The process described in the immediately preceding paragraph continues with the acquisition of a third set of image portions 208 from a third partial image 210. Each of the image portions of the third set 208 comprises a number of rows of pixels, with the number of rows of pixels determined on the basis of the new data determined in respect of the first and second sets of image portions 200, 204. The first row of each image portion of the second set of image portions 204 is compared with each row of the corresponding image portion of the third set of image portions 208 to determine the new data. This process continues as further sets of image portions 212 are acquired from further partial images 214. As can be seen from FIG. 8, image portions within a particular set of image portions can have different heights (i.e. comprise different numbers of rows of pixels). This is because the number of rows in an image portion depends on previously determined new data.

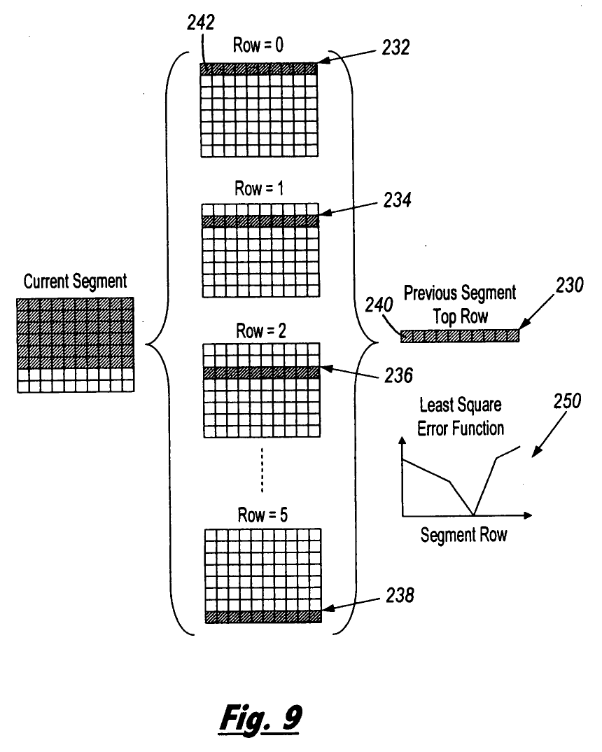

The determination of new data of corresponding image portions will now be described with reference to FIG. 9. The determination of the new data is based on a minimum least squares approach. The minimum least squares approach can be expressed as:

E=Σ(Pⁿ_{i,j}−Pⁿ⁺¹_{i,j})²

where E is the error for a row to row comparison of corresponding image portions, Pⁿ_{i,j} is a value of a pixel in a two dimensional array of pixels in one image portion (i.e. the n^{th} image portion), Pⁿ⁺¹_{i,j} is the corresponding pixel value in a two dimensional array of pixels in the next image portion (i.e. the n^{th}+1 image portion), and the Σ operator denotes the summation of squared pixel value differences determined for all pairs of pixels in the rows of the two image portions.

As described above, a row of pixels 230 in a first image portion of two corresponding image portions is compared with each row 232 to 238 in the second image portion of the corresponding image portions. The row of pixels 230 contains new data determined previously for the first image portion. More specifically, a first row 230 of the first image portion is compared with a first row 232 of the second image portion by taking a first pixel 240 in the row and subtracting its value from the value of the first pixel 242 in the first row 232 of the second image portion. The thus obtained difference value is squared. This process is repeated for the second, fourth, fifth, etc pairs of pixel values in the first and second image portions until squared values have been obtained for all the pixels in the first rows 230, 232 of the first and second image portions. The squared values are then summed to provide an error value for the first row to first row comparison. Then the first row 230 of the first image portion is compared with the second row 234 of the second image portion by the same approach as for the first rows of the first and second image portions to provide an error value for the first row 230 to second row 234 comparison. Then the first row 230 of the first image portion is compared with the third row 236 of the second image portion by the same approach to provide an error value for the first row 230 to third row 236 comparison. The process continues until the first row 230 of the first image portion has been compared with each row 232 to 238 of the second image portion. Thus, an error value is provided for each row to row comparison. Finally, the error values are compared with each other, as represented in the graph 250 shown in FIG. 9, to determine the lowest error value. Thus, where the row of pixels 230 in the first image portion is the last row in the first image portion, the lowest error value indicates the last row of the rows common to both first and second image portions. The rest of the rows of the second image portions are new data absent from the first image portion.

The number of rows of pixels of the second image portion with which the row of pixels 230 of the first image portion is compared is determined in accordance with a cost error function. In addition, the number of pixels (e.g. every pixel or every third pixel) compared within each of a pair of rows being compared is determined in accordance with the cost error function. Thus, the cost error function controls an extent and resolution of the comparison process.

Already determined new data for corresponding image portions is used to reduce the computational burden shouldered in respect of determining new data for further corresponding image portions. More specifically, already determined new data is used to reduce the number of rows of an image portion with which the first row of another corresponding image portion is compared. For example, where each image portion is six rows high and new data is determined to be three, the next new data determination will involve comparing the first row of one image portion with the second, third and fourth rows of the other image portion instead of all six rows of the other image portion. Furthermore, determined new data is used to change the number of rows of pixels in an acquired image portion. The extent of the comparison and the number of rows in an image portion are changed by changing the cost error function. Also, the number of pixels compared in a pair of rows of pixels is changed by changing the cost error function. Continuing with the example given in the present paragraph, the number of rows of pixels in a newly acquired image portion is reduced to four from six. Alternatively or in addition, the time period between the acquisition of one image portion and the next can be reduced. For example, where there are few rows of new data the acquisition time period is increased; or where there are many rows of new data the acquisition time period is decreased.

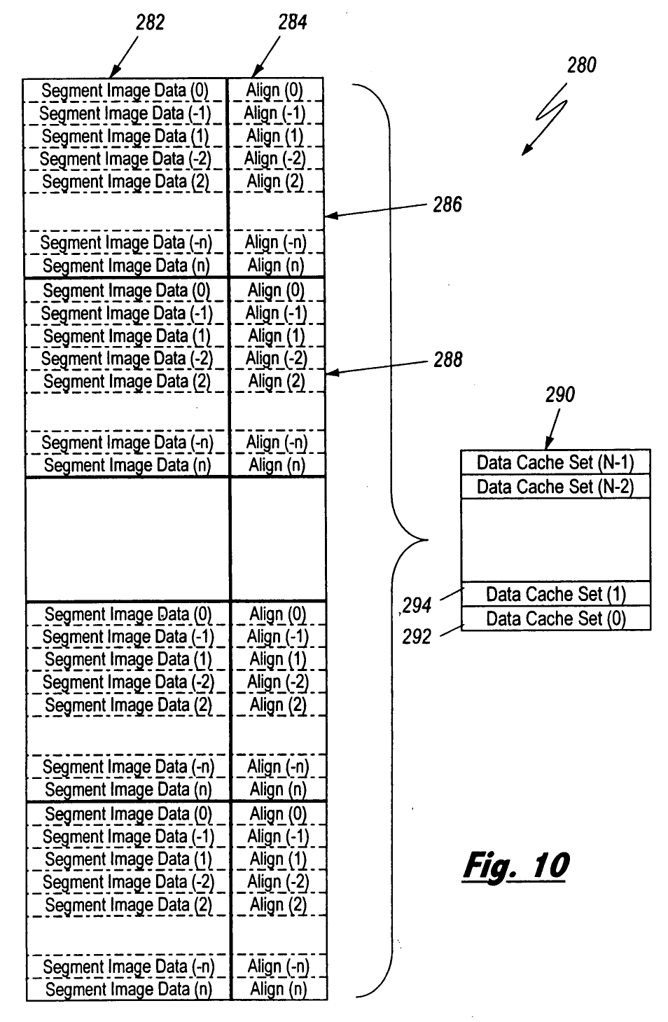

The caching 94 of image portions will now be described with reference to FIG. 10. As described above, new data of an image portion is determined with respect to the corresponding next acquired image portion. Thus, the new data of the image portion is known and the image data common to the corresponding image portions is now redundant. Hence, the image portion is cached in data memory 18 without the rows containing the common image data to thereby reduce memory storage requirements. In addition, the location of the image portion acquired from a particular partial image in relation to the other image portions in the partial image is stored in data memory 18. For example, the location of an image portion acquired from a centre most part of a partial image is indicated by the storage of a ‘0’; the location of an image portion acquired from a part of the partial image immediately to one side of the centre most location is indicated by the storage of a ‘−1’; the location of an image portion acquired from a part of the partial image immediately to an opposing side of the centre most location is indicated by the storage of a ‘1’; etc. This process is illustrated in FIG. 10 in which the left hand column 282 contains all image portions acquired from a series of partial images and the right hand column 284 contains the relative locations of the image portions. The left and right columns 282, 284 are sub-divided into blocks of data for each partial image in turn. Thus, the first block of data 286 contains image portions and relative locations for a first partial image; the second block of data 288 contains image portions and relative locations for a second partial image; etc. The block of data 290 towards the right hand side of FIG. 10 represents how the image portions and their relative locations are stored in data memory 18. More specifically, image portions and relative locations for the first partial image are stored, as data cache set ‘0’, 292 towards the end of the data memory. Then image portions and relative locations for the second partial image are stored, as data cache set ‘1’, 294 in the next part of data memory 18. This process continues until image portions and relative locations for all the partial images have been cached in data memory, with the data ordered such that the most recently acquired image portions are stored towards the start of the data memory. This ordering enables the same block of data memory to be used for the image formation process 98.

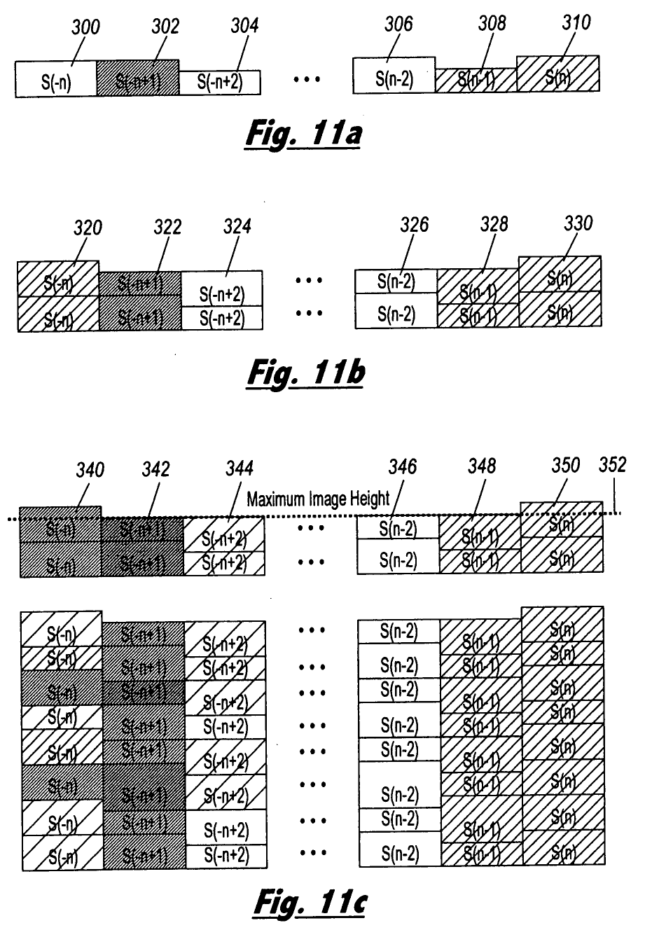

The formation of a composite fingerprint image from a number of image portions will now be described with reference to FIGS. 11a to 11c. The cached image portions are used in the formation of a composite image. The process begins by recovering from data memory 18 the −n image portion from the first cached data set 292, as shown in FIG. 10. The −n image portion 300 is placed in the bottom left hand corner of the composite image being formed. As mentioned above, the composite image is formed in the same part of data memory 18 storing the cached image portions. Next, the −n+1 image portion 302 is recovered from the first cached data set 292 held in data memory 18 and is placed in the composite image being formed adjacent the already placed −n image portion. The process is repeated for all the image portions 304 to 310 remaining in the first data set to form a first row of the composite image being formed. As can be seen from FIG. 11a, the image portions 300 to 310 in the first row are of different heights; this reflects the different new data determined in respect of each image portion and its corresponding image portion acquired from the next partial image. The process now turns to the image portions contained in the second cached data set 294, as shown in FIG. 10. More specifically and as shown in FIG. 11b, the image portions 320 to 330 of the second cached data set and are recovered in turn from data memory 18 and placed adjacent their corresponding already placed image portions from the first cached data set. The process is repeated for image portions 340 to 350 in each of the remaining cached data sets to thereby build the composite fingerprint image from the bottom upwards. The process of adding further rows corresponding to partial images to the composite fingerprint image terminates either when all cached image portions have been recovered from data memory 18 and placed in the composite fingerprint image or when the composite fingerprint image is of a height greater than predetermined fingerprint image height 352.

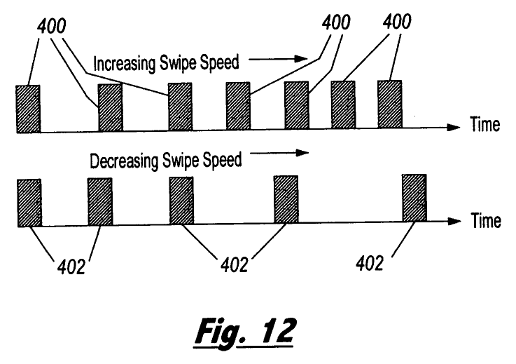

The time period between the acquisition of one image portion and the next can be changed in dependence upon one or more sets of new data determined in respect of corresponding image portions. If a speed of movement of a fingerprint over a sensor increases during the acquisition of a series of partial images, a size of new data (i.e. the number of rows in the new data) will increase. Alternatively, if a speed of movement of a fingerprint over a sensor decreases during the acquisition of a series of partial images, the size of new data will decrease. To keep the size of new data from image portion to image portion within desired limits and thereby provide for optimal performance the time period between the acquisition of one image portion and the next is changed. As shown in FIG. 12, where the fingerprint speed of movement increases, the acquisition time period is reduced such that a series of acquired image portions 400 become more closely spaced. Also as shown in FIG. 12, where the fingerprint speed of movement decreases, the acquisition time period is increased such that a series of acquired image portions 402 become further spaced apart.

What is claimed is:

1. A method of forming a composite biometric image, the method comprising:
sensing first and second successive partial images of a biometric object with a sensor during relative movement of the biometric object and the sensor, the sensor comprising an array of sensing elements defining an area smaller than an area of the biometric object to be formed as the composite biometric image, the first and second successive partial images overlapping each other along a direction of the relative movement;
acquiring at least a first image portion and a second image portion from each of the first and second sensed partial images, the first image portion and the second image portion of each comprising different sensed image data along a direction orthogonal to a direction of relative movement of the biometric object and the sensor, the first image portions overlapping with each other, and the second image portions overlapping with each other;
determining first new data of the first image portion of the second partial image absent from the first image portion of the first partial image;
determining second new data of the second image portion of the second partial image absent from the second image portion of the first partial image; and
forming the composite biometric image from the image portions in dependence upon the determined first and second new data.

2. A method according to claim 1, in which the array of sensor elements is at least as wide as and has a length shorter than the area of the biometric object for which a composite biometric image is to be formed.

3. A method according to claim 1, in which at least one of: the first image portions of the first and second partial images; and the second image portions of the first and second partial images are of substantially the same size in the direction orthogonal to the direction of relative movement.

4. A method according to claim 3, in which corresponding image portions of the first and second partial images comprise a same number of pixels in the direction orthogonal to the direction of relative movement.

5. A method according to claim 1, in which determining new data comprises determining new data along the direction of relative movement.

6. A method according to claim 1, in which at least one of: the first image portions of the first and second partial images; and the second image portions of the first and second partial images are of substantially the same size along the direction of relative movement.

7. A method according to claim 1, in which corresponding image portions of the first and second partial images comprise a same number of pixels along the direction of relative movement.

8. A method according to claim 1, in which at least one of: respective image portions of the first and second partial images are acquired successively from substantially the same part of the sensor array.

9. A method according to claim 1, in which the first and second image portions of a partial image abut each other along a direction orthogonal to the direction of relative movement.

10. A method according to claim 1, in which the method comprises acquiring a plurality of image portions from a sensed partial image such that image data sensed by some of the sensing elements of the sensor is acquired.

11. A method according to claim 10, in which the method comprises providing at least one inferred portion from the acquired plurality of image portions, the at least one inferred image portion comprising image data inferred from the acquired image portions.

12. A method according to claim 11, in which the at least one inferred image portion is provided by extrapolation of data contained within at least one of the acquired image portions.

13. A method according to claim 11, in which the acquired plurality of image portions comprise two abutting acquired image portions and the at least one inferred image portion comprises three abutting inferred image portions.

14. A method according to claim 13, in which a centrally disposed one of the three abutting inferred image portions consists of image data from each of the two abutting acquired image portions.

15. A method according to claim 13, in which a peripherally disposed one of the three abutting inferred image portions comprises image data from one of the two abutting acquired image portions and image data inferred from the image data of the same one of the two abutting acquired image portions.

16. A method according to claim 1, in which the method comprises changing a size of an image portion acquired from one partial image to an image portion acquired from a succeeding partial image.

17. A method according to claim 16, in which changing the size comprises at least one of: changing the size along the direction of relative movement; and changing the size along a direction orthogonal to the direction of relative movement.

18. A method according to claim 1, in which the first partial image has been sensed before the second partial image.

19. A method according to claim 1, in which the at least one of the first and second new data of corresponding image portions of the first and second partial images are determined by comparing the corresponding image portions.

20. A method according to claim 19, in which the first and second image portions comprise a plurality of rows of pixels.

21. A method according to claim 20, in which determining the new data comprises comparing values of at least one row of pixels of the image portion of the first partial image with values of at least a first row of pixels of the image portion of the second partial image.

22. A method according to claim 21, in which the at least one row of the first partial image that is compared contains new data already determined in respect of the first partial image.

23. A method according to claim 21, in which the number of rows of the image portions compared with each other and/or the number of pixels of a total number of pixels in rows that are subject to comparison are determined in accordance with a cost error function.

24. A method according to claim 19, in which a predetermined number of pixels of a row of the image portion of the first partial image are compared with a predetermined number of pixels of a row of the image portion of the second partial image.

25. A method according to claim 24, in which the predetermination is in accordance with a cost error function.

26. A method according to claim 19, in which the step of comparing comprises determining a difference.

27. A method according to claim 19, in which determining the new data comprises determining a difference between values of at least one pair of corresponding pixels, a first one of the pair of pixels being from one image portion and a second one of the pair of pixels being from the other image portion.

28. A method according to claim 27, in which determining the new data comprises subtracting values of each of a plurality of pixels in a row of the image portion of the first partial image from a value of a corresponding pixel in a row of the image portion of the second partial image.

29. A method according to claim 28, in which determining the new data comprises subtracting values of each of a plurality of pixels in a first row of the image portion of the first partial image from a value of a corresponding pixel in at least a first row of the image portion of the second partial image.

30. A method according to claim 29, in which determining the new data comprises subtracting values of each of a plurality of pixels in a first row of the image portion of the first partial image from a value of a corresponding pixel in each of a plurality of rows of the image portion of the second partial image.

31. A method according to claim 1, in which determining the new data comprises determining a square of a difference determined by subtraction of pixel values.

32. A method according to claim 1, in which determining the new data comprises summing a plurality of differences determined by subtraction of pixel values.

33. A method according to claim 1, in which determining the new data comprises summing differences determined in respect of at least one row of the image portion of the second partial image.

34. A method according to claim 33, in which, where pixel values of a row of the image portion for the first partial image are subtracted from corresponding pixel values in each of a plurality of rows of the image portion of the second partial image, a plurality of summed differences are determined, each of the plurality of summed differences being in respect of a different one of the plurality of rows of the image portion of the second partial image.

35. A method according to claim 34, in which new data of the corresponding image portions is determined in dependence on a comparison of the plurality of summed differences.

36. A method according to claim 35, in which the new data is determined based on the smallest summed difference of the plurality of summed differences.

37. A method according to claim 36, in which the new data is determined on the basis of a Minimum Least Squares (MLS) approach.

38. A method according to claim 1, in which the first new data of the first image portions is determined before the second new data of the second image portions where the first image portions have been acquired from closer to a centre of their respective partial images than the second image portions.

39. A method according to claim 1, in which at least one set of new data is used to make a determination as to a speed of movement of the biometric object and the sensor in relation to each other.

40. A method according to claim 39, in which the method further comprises the step of comparing a size, along the direction of relative movement, of new data of corresponding image portions with a predetermined movement value and if the size is greater than the predetermined movement value, determining that there is insufficient movement of the biometric image and the sensor in relation to each other.

41. A method according to claim 1, in which the image portions are acquired from towards a centre of each of the first and second partial images.

42. A method according to claim 1, in which an image portion acquired from the first partial image comprises one row of pixels and an image portion acquired from the second partial image comprises a plurality of rows of pixels.

43. A method according to claim 42, in which a number of rows of pixels in the image portion acquired from the second partial image is determined in dependence upon at least one of: a maximum anticipated speed of movement of the biometric object and the sensor in relation to each other; and a rate of acquisition of image portions.

44. A method according to claim 39, in which in making the determination as to the speed of movement, a comparison is made between the row of pixels of the first partial image and each row of pixels of the second partial image.

45. A method according to claim 39, in which making a determination as to the speed of movement comprises determining new data for at least two pairs of image portions acquired from a predetermined number of successive pairs of partial images.

46. A method according to claim 45, in which making a determination as to the speed of movement further comprises comparing the determined new data.

47. A method according to claim 46, in which movement of the biometric object and the sensor in relation to each other is indicated when sizes along the direction of relative movement of new data from partial image to partial image are substantially constant.

48. A method according to claim 1, in which a speed of movement of the biometric object and the sensor in relation to each other is determined from the determined new data.

49. A method according to claim 1, in which at least one of an acquisition rate and a size of a current image portion acquired from a partial image is determined in dependence upon new data determined in respect of already acquired corresponding image portions.

50. A method according to claim 1, in which the determination of new data is changed in dependence upon new data determined in respect of already acquired corresponding image portions.

51. A method according to claim 50, in which a number of computation steps involved in the determination of new data is changed in dependence upon new data determined in respect of already acquired corresponding image portions.

52. A method according to claim 51, in which an extent to which corresponding image portions are compared to each other is changed.

53. A method according to claim 52, in which, where determining new data comprises comparing one row of pixels of an image portion of a first partial image with each of a plurality of rows of pixels of an image portion of a second partial image, the extent to which the image portions are compared to each other is changed by changing a number of rows of pixels of the image portion of the second partial image with which the row of pixels of the image portion of the first partial image is compared.

54. A method according to claim 1, in which acquisition of further image portions from the second partial image is in dependence upon at least one of the first and second new data determined in respect of the pairs of first and second image portions.

55. A method according to claim 1, in which determination of new data of further pairs of image portions is in dependence upon at least one of the new data determined in respect of the pairs of first and second image portions.

56. A method according to claim 1, in which at least one image portion is stored in data memory.

57. A method according to claim 56, in which the at least one image portion is stored along with data indicating the location of the image portion in a partial image along a direction orthogonal to the direction of relative movement.

58. A method according to claim 56, in which the at least one image portion is stored along with data indicating a particular partial image from which the image portion has been acquired of a plurality of partial images sensed during relative movement of the biometric object and the sensor.

59. A method according to claim 1, in which the first and second image portions of each of the first and second partial images are stored in data memory and in which the second partial image is sensed after the first partial image, an image portion of the second partial image being stored in data memory along with its disposition in relation to the corresponding image portion of the first partial image.

60. A method according to claim 1, in which the first and second image portions of each of the first and second partial images are stored in data memory and an extent to which an image portion of the second partial image is stored in data memory depends on its determined new data.

61. A method according to claim 60, in which, where the image portion comprises a plurality of rows of pixels, at least none of the rows of pixels of the image portion is stored in data memory.

62. A method according to claim 1, in which data stored in data memory is compressed.

63. A method according to claim 56, in which the at least one image portion is stored in data memory between acquisition of image portions from the second partial image and the acquisition of image portions from further partial images.

64. A method according to claim 56, in which, where a plurality of image portions from a partial image are stored in data memory, an image portion of the plurality of image portions that is located centre most in the partial image is stored in data memory first.

65. A method according to claim 64, in which a second image portion adjacent the centre most image portion is stored next in the data memory.

66. A method according to claim 65, in which a third image portion adjacent the centre most image portion and opposing the second image portion is stored next in the data memory.

67. A method according to claim 56, in which the composite biometric image is formed from data of at least one image portion stored in data memory.

68. A method according to claim 1, in which the step of forming the composite biometric image comprises forming a first image column from data of the first image portions of the at least first and second partial images and forming a second image column from data of the second image portions of the at least first and second partial images.

69. A method according to claim 68, in which an image column is formed by disposing its respective image portion data such that data of neighbouring image portions abut each other at edges having a direction substantially orthogonal to the direction of relative movement.

70. A method according to claim 68, in which the step of forming the composite biometric image further comprises disposing image columns in relation to each other.

71. A method according to claim 70, in which the first image column and the second image column are disposed such that they abut each other at edges having a direction substantially along the direction of relative movement.

72. A method according to claim 68, in which the first image column and the second image column are aligned with each other along the direction of relative movement.

73. A method according to claim 72, in which the first and second image columns are aligned such that a free edge of data of an image portion of the first image column is in registration with a free edge of data of an image portion of the second image column.

74. A method according to claim 73, in which the image portion data having the free edge has been acquired from a first partial image sensed during relative movement of the sensor and the biometric object being used in formation of the composite biometric image.

75. A method according to claim 68, in which the first image column is formed before the second image column, the first image column having data from image portions that have been acquired from closer to a periphery of the partial images than data from the image portions comprised in the second image column.

76. A method according to claim 1, in which the step of forming a composite biometric image comprises disposing data from a plurality of image portions acquired from a first partial image in relation to each other followed by disposing data from a plurality of image portions acquired from a second partial image in relation to each other.

77. A method according to claim 76, in which the step of forming the composite biometric image continues until at least one of: a height of the thus formed composite biometric image along the direction of relative movement exceeds a predetermined height value; and data from all image portions acquired from sensed partial images have been disposed in image columns.

78. A method according to claim 1, in which an image portion is acquired from a partial image and new data is determined in respect of the image portion before a further image portion is acquired from a partial image.

79. A method according to claim 1, in which at least one pixel in an image portion consists of binary data.

80. A method according to claim 1, in which the method comprises processing at least one pixel of an image portion to improve upon the use of a dynamic range of the pixel by the data contained in the pixel.

81. A method according to claim 80, in which processing at least one pixel comprises applying compression to the data contained in the pixel.

82. A method according to claim 81, in which logarithmic compression is applied to the data contained in the at least one pixel.

83. A method according to claim 80, in which at least one pixel of an image portion is processed in dependence upon data contained in at least one pixel of at least one of: a currently sensed partial image; and a previously sensed partial image.

84. A method according to claim 80, in which at least one pixel of an image portion is processed in dependence on an average amplitude of data contained in pixels of at least one partial image.

85. A method according to claim 80, in which the processing of at least one pixel is in dependence upon a determination of new data for corresponding image portions.

86. A method according to claim 80, in which at least one pixel of a plurality of pixels of an image portion is selectively processed in dependence upon determined new data for corresponding image portions.

87. A method according to claim 1, in which the method further comprises controlling an acquisition time between acquisition of one image portion and another image portion in dependence upon a determination of new data for already acquired corresponding image portions.

88. A method according to claim 87, in which the method further comprises comparing a size of the new data with at least one predetermined size value and controlling the acquisition time in dependence upon the comparison.

89. A method according to claim 88, in which the at least one predetermined size value comprises a high size value and a low size value and the acquisition time is controlled to maintain the size of the new data between the high size value and the low size value.

90. A method according to claim 88, in which the acquisition time is reduced if the size of the new data is less than or equal to half the height of an image portion.

91. A method according to claim 1, in which the biometric object comprises a fingerprint.

92. A method according to claim 1, in which the sensor is operative to sense the biometric object on the basis of a thermal principle.

93. A computer program comprising executable code that upon installation on a computer comprising a sensor causes the computer to form a composite biometric image by executing the procedural steps of:
sensing first and second successive partial images of a biometric object with the sensor during relative movement of the biometric object and the sensor, the sensor comprising an array of sensing elements defining an area smaller than an area of the biometric object to be formed as the composite biometric image, the first and second successive partial images overlapping each other along a direction of the relative movement,
acquiring at least a first image portion and a second image portion from each of the first and second sensed partial images, the first image portion and the second image portion of each comprising different sensed image data along a direction orthogonal to a direction of relative movement of the biometric object and the sensor, the first image portions overlapping with each other, and the second image portions overlapping with each other;
determining first new data of the first image portion of the second partial image absent from the first image portion of the first partial image;
determining second new data of the second image portion of the second partial image absent from the second image portion of the first partial image; and
forming the composite biometric image from the image portions in dependence upon the determined first and second new data.

94. A computer program according to claim 93, in which the computer program is stored in at least one of: a data carrier; read-only memory; and computer memory.

95. A computer program according to claim 93, in which the computer program is carried on an electrical carrier signal.

96. An apparatus for forming a composite biometric image, the apparatus comprising:
a sensor operative to sense first and second successive partial images of a biometric object during relative movement of the biometric object and the sensor, the sensor comprising an array of sensing elements defining an area smaller than an area of the biometric object to be formed as the composite biometric image, the apparatus being operative to sense the first and second successive partial images such that they overlap each other along a direction of the relative movement;
data acquisition apparatus operative to acquire at least a first image portion and a second image portion from each of the first and second sensed partial images such that: the first image portion and the second image portion of each comprises different sensed image data along a direction orthogonal to a direction of relative movement of the biometric object and the sensor, the first image portions overlap each other, and the second image portions overlap each other; and
a processor operative to: determine first new data of the first image portion of the second partial image absent from the first image portion of the first partial image; determine second new data of the second image portion of the second partial image absent from the second image portion of the first partial image; and form the composite biometric image from the image portions in dependence upon the determined first and second new data.

97. An apparatus according to claim 96, in which the apparatus comprises a computer, the computer comprising the processor and the data acquisition apparatus.

98. An apparatus according to claim 97, in which the computer further comprises data memory operative to store at least one of: the image portions; and the composite biometric image.

99. An apparatus according to claim 96, in which the computer comprises the sensor.

100. An apparatus according to claim 96, in which the apparatus comprises an embedded microcomputer, the processor forming part of the embedded microcomputer.

101. An apparatus according to claim 96, in which the sensor consists of two rows of sensor elements.
